(19) United States
(12) Patent Application Publication
(10) Pub. No.: US 2026/0285433 A1
(43) Pub. Date: Sep. 24, 2026

(54) MOTORCYCLE SEAT ASSEMBLIES

(71) Applicant: Indian Motorcycle International, LLC, Medina, MN (US)

(72) Inventors: Michael W. Rafferty, New Brighton, MN (US); Keith B. Steidl, Blaine, MN (US); Michael M. Song, Maple Grove, MN (US); Kyle R. Kujawa, Metamora, MI (US)

(21) Appl. No.: 19/576,916

(22) Filed: Mar. 24, 2026

Related U.S. Application Data
(60) Provisional application No. 63/776,513, filed on Mar. 24, 2025.

(51) Int. Cl. B62J 9/14; B62J 1/08; B62J 43/20

(52) U.S. Cl. CPC B62J 9/14; B62J 1/08; B62J 43/20

(57) ABSTRACT

A seat assembly for a vehicle includes a rim portion and cushion assembly. The rim portion is configured for coupling with a frame of the vehicle, and the rim portion includes an aperture. The cushion assembly is detachably coupled to the rim portion. The cushion assembly includes a lower base positioned in the aperture when the cushion assembly is coupled to the rim portion. The cushion assembly further includes an inner base coupled to the lower base and a cushion portion coupled to the inner base.

### PRIORITY APPLICATIONS

This application claims the benefit of priority to U.S. Provisional Patent Application Ser. No. 63/776,513, filed Mar. 24, 2025, the content of which is incorporated herein by reference in its entirety.

### TECHNICAL FIELD

The present application relates generally to vehicle seat assemblies and more particularly to floating seating assemblies for two-wheeled or three-wheeled vehicles, such as motorcycles.

### BACKGROUND

Some vehicles, such as motorcycles, include “floating” seat assemblies in which a portion of the structure is positioned above and defines a gap between an adjacent portion of the vehicle's frame.

### SUMMARY

Complex mechanical arrangements are, in some examples, used with floating seat assemblies, such as support springs and large quantities of fasteners that may affect the appearance and/or production of such seat assemblies. Moreover, such seat assemblies are typically subjected to design constraints (for example, manufacture/assembly and size constraints) that render them uncomfortable. Accordingly, improved floating seat assemblies would be beneficial.

In one aspect, a seat assembly for a vehicle includes a rim portion and cushion assembly. The rim portion is configured to be coupled to a frame of the vehicle, and the rim portion includes an aperture. The cushion assembly is detachably coupled to the rim portion. The cushion assembly includes a lower base positioned in the aperture when the cushion assembly is coupled to the rim portion. The cushion assembly further includes an inner base coupled to the lower base and a cushion portion coupled to the inner base.

In another aspect, the aperture is a rim aperture, the lower base includes a base aperture, and the inner base is coupled to the rim portion at the base aperture.

In another aspect, the seat assembly further includes a fastener coupling the inner base to the rim portion at the base aperture.

In another aspect, the fastener is detachable from the inner base and the rim portion to facilitate detachment of the cushion assembly from the rim portion.

In another aspect, the seat assembly further includes a fastener coupling the cushion assembly to the rim portion, and the fastener is detachable from the cushion assembly and the rim portion to facilitate detachment of the cushion assembly from the rim portion.

In another aspect, the cushion assembly includes a latch detachably coupling the cushion assembly to the rim portion.

In another aspect, the cushion assembly further includes a cushion cover overlying the cushion portion.

In another aspect, the seat assembly further includes fasteners coupling the cushion cover to the cushion portion.

In another aspect, the fasteners are at least partially obscured by the rim portion when the cushion assembly is coupled to the rim portion.

In another aspect, the fasteners are staples.

In another aspect, the rim portion is constructed of a metal, the lower base is constructed of a polymer, and the inner base is constructed of a metal.

In another aspect, the cushion portion has a middle section with a middle thickness and a side section with a side thickness, and the side thickness is less than the middle thickness.

In another aspect, the middle thickness is in a range of 37 mm to 47 mm and the side thickness is in a range of 7 mm to 17 mm.

In another aspect, the cushion portion has a middle section with a middle thickness and a rear section with a rear thickness, and the rear thickness is less than the middle thickness.

In another aspect, the middle thickness is in a range of 37 mm to 47 mm and the rear thickness is in a range of 7 mm to 17 mm.

In another aspect, the cushion assembly includes a concave upper surface and a convex lower surface.

In another aspect, the cushion portion includes an upper cushion layer and a lower cushion layer.

In another aspect, the upper cushion layer has a first spring rate, the lower cushion layer has a second spring rate, and the second spring rate is greater than the first spring rate.

In one aspect, a vehicle includes a frame including an internal compartment, and the internal compartment has an access opening.

In another aspect, a compartment cover is detachably coupled to the frame and adjacent to the access opening of the internal compartment. A seat assembly is coupled to the frame, and the seat assembly includes a rim portion and a cushion assembly. The rim portion is coupled to the frame and includes an aperture. The cushion assembly is detachably coupled to the rim portion adjacent to the aperture of the rim portion. The cushion assembly is detachable from the rim portion and the compartment cover is moveable relative to the frame to permit access to the internal compartment through the aperture and the access opening.

In another aspect, the cushion assembly includes a cushion portion and a lower base coupled to the cushion portion. The lower base is positioned in the aperture of the rim portion when the cushion assembly is coupled to the rim portion.

In another aspect, the cushion assembly further includes a latch that is selectively detachable from the rim portion to facilitate detachment of the cushion assembly from the rim portion.

In another aspect, the cushion assembly further includes an inner base disposed between the cushion portion and the lower base.

In another aspect, the aperture is a rim aperture, the lower base includes a base aperture, and the inner base contacts the rim portion at the base aperture.

In another aspect, the vehicle further includes a fastener coupling the inner base to the rim portion at the base aperture.

In another aspect, the fastener is detachable from the inner base and the rim portion to facilitate detachment of the cushion assembly from the rim portion.

In another aspect, the rim portion is constructed of a metal, the lower base is constructed of a polymer, and the inner base is constructed of a metal.

In another aspect, the cushion assembly includes a cushion portion and a cushion cover overlying the cushion portion.

In another aspect, the vehicle further includes fasteners coupling the cushion cover to the cushion portion, and the fasteners are obscured by the rim portion when the cushion assembly is coupled to the rim portion.

In another aspect, the fasteners are staples.

In another aspect, the seat assembly includes a front section secured to the frame and a rear section disposed above the compartment cover, and the rear section and the compartment cover define a gap therebetween.

In another aspect, the vehicle further includes at least one of a battery and a fuse assembly disposed within the internal compartment.

In another aspect, the vehicle is a two-wheeled vehicle.

In one aspect, a seat assembly for the vehicle includes a rim portion configured to be coupled to a frame of the vehicle, and the rim portion includes an aperture. A cushion assembly is positioned in the aperture, and the cushion assembly includes a latch detachably coupling the cushion assembly to the rim portion. A first fastener detachably couples the cushion assembly to the rim portion, and a second fastener detachably couples the cushion assembly to the rim portion.

In another aspect, the latch is disposed at a front section of the seat assembly.

In another aspect, the first fastener is disposed at a first side section of the seat assembly and the second fastener is disposed at a second side section of the seat assembly.

In another aspect, the cushion assembly includes a concave upper surface and a convex lower surface.

In another aspect, the cushion assembly includes a lower base and cushion portion, and the lower base is positioned in the aperture when the cushion assembly is coupled to the rim portion.

In another aspect, the cushion portion has a middle section with a middle thickness and a side section with a side thickness, and the side thickness is less than the middle thickness.

In another aspect, the middle thickness is in a range of 37 mm to 47 mm and the side thickness is in a range of 7 mm to 17 mm.

In another aspect, the cushion portion has a middle section with a middle thickness and a rear section with a rear thickness, and the rear thickness is less than the middle thickness.

In another aspect, the middle thickness is in a range of 37 mm to 47 mm and the rear thickness is in a range of 7 mm to 17 mm.

In another aspect, the cushion assembly further includes an inner base disposed between the lower base and the cushion portion.

In another aspect, the aperture is a rim aperture, the lower base includes a base aperture, and the inner base contacts the rim portion at the base aperture.

In another aspect, the first fastener couples the inner base to the rim portion at the base aperture.

In another aspect, the cushion assembly includes a cushion portion, a cushion cover, and a plurality of fasteners coupling the cushion cover to the cushion portion.

In another aspect, the rim portion obscures the plurality of fasteners when the cushion assembly is coupled the rim portion.

### BRIEF DESCRIPTION OF THE DRAWINGS

The subject matter discussed above and other features of this disclosure, and the manner of attaining them, will become more apparent and the disclosure itself will be better understood by reference to the following description of embodiments of the disclosure taken in conjunction with the accompanying drawings, wherein:

FIG. 1 is a rear perspective view of a vehicle, according to an embodiment of the present disclosure;

FIG. 2 is a rear perspective view of the vehicle of FIG. 1 further illustrating a seat assembly thereof, according to an embodiment of the present disclosure;

FIG. 3 is a front perspective view of the vehicle of FIG. 1 further illustrating the seat assembly of FIG. 2;

FIG. 4 is a bottom perspective view of the seat assembly of FIG. 2;

FIG. 5 is an exploded top perspective view of the seat assembly of FIG. 2;

FIG. 6 is an exploded bottom perspective view of the seat assembly of FIG. 2;

FIG. 7 is a rear section view of the seat assembly of FIG. 2;

FIG. 8 is a side section view of the seat assembly of FIG. 2;

FIG. 9 is a view of the seat assembly within line 9 -9 of FIG. 7;

FIG. 10 is a view of the seat assembly within line 10 -10 of FIG. 8;

FIG. 11 is a bottom perspective view of the seat assembly of FIG. 2 with a rim portion thereof illustrated with phantom lines;

FIG. 12 is a rear perspective view of a cushion assembly of the seat assembly of FIG. 2 being detached from the rim portion;

FIG. 13 is a rear perspective view of a battery of the vehicle being detached through an aperture of the rim portion;

FIG. 14 is a rear perspective view of the seat assembly of FIG. 2 and an additional backrest assembly; and

FIG. 15 is a front view of the backrest assembly of FIG. 14.

Corresponding reference characters may indicate corresponding parts throughout the several views.

### DETAILED DESCRIPTION OF THE DRAWINGS

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

While the structures and components disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated.

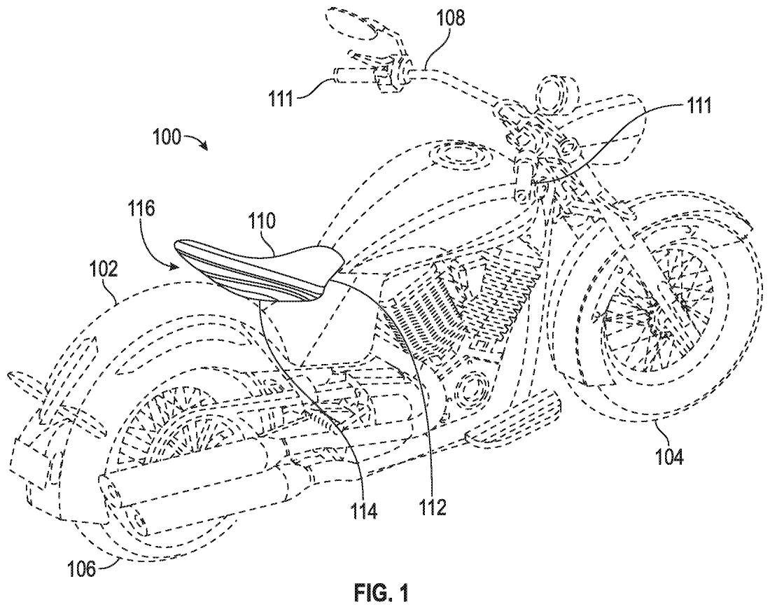

Referring now to FIG. 1, an illustrative embodiment of a vehicle 100 is shown. The vehicle 100 is illustrated as a two-wheeled vehicle, such as a cruiser-style motorcycle, although the vehicle 100 may take other forms, such as other two-wheeled vehicles, three-wheeled vehicles, four-wheeled vehicles, or the like. The vehicle 100 generally includes a frame 102 supported by ground engaging members, such as a front ground engaging member or wheel 104 and a rear ground engaging member or wheel 106. The vehicle 100 travels relative to the ground on the front wheel 104 and the rear wheel 106. The rear wheel 106 is coupled to a power train assembly to propel the vehicle 100 via rotation of the rear wheel 106. The vehicle 100 also generally includes a steering assembly 108, a front suspension, a rear suspension, and a seat assembly 110. The steering assembly 108 includes handlebars 111 that are movable by an operator to orient the front wheel 104 either to the left or the right.

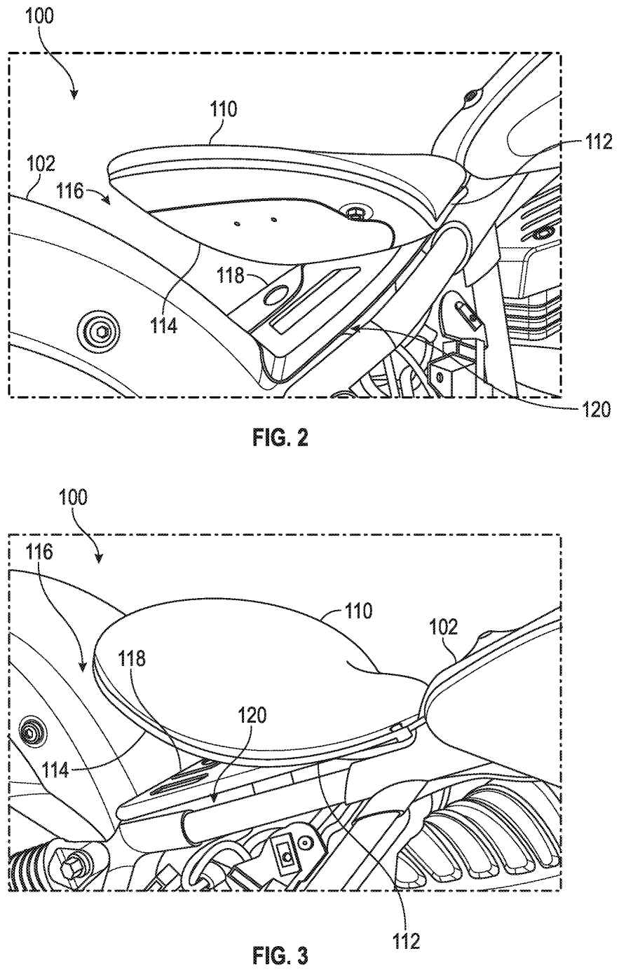

With continued reference to FIG. 1 and additional reference to FIGS. 2 and 3, the seat assembly 110 is configured to support an operator during use of the vehicle 100. The seat assembly 110 may be referred to as a “floating” seat assembly. Stated another way, the seat assembly 110 includes a front section 112 that is secured to a seat supporting portion of the frame 102 and a rear section 114 that is disposed apart from and above the seat supporting portion of the frame 102 (e.g., cantilevered), the seat assembly 110 and the frame 102 thereby defining a gap 116 therebetween. For example, the rear section 114 of the seat assembly 110 is disposed apart from and above a compartment cover 118 (FIGS. 2 and 3) coupled to the frame 102. As described in further detail below, the compartment cover 118 is selectively movable relative to the frame 102 (for example, detachable, pivotable, and/or slidable relative to the frame 102), to permit access to an internal compartment via an access opening 120.

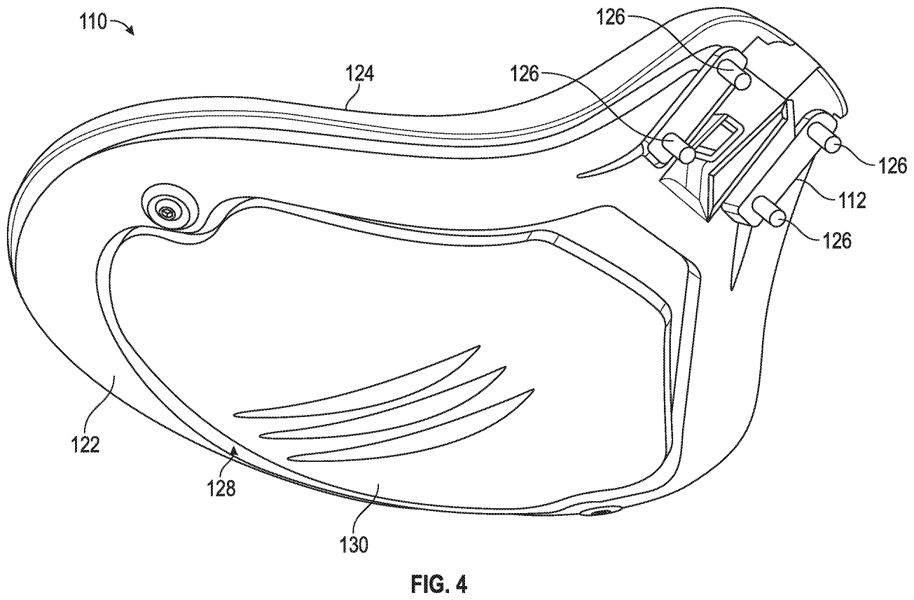

FIGS. 4-6 illustrate the seat assembly 110 in further detail. The seat assembly 110 generally includes a rim portion 122, also referred to as a mount portion, that detachably mounts a cushion assembly 124. The rim portion 122 couples to the frame 102 of the vehicle 100 (shown elsewhere) at the front section 112 of the seat assembly 110, illustratively, via a plurality of fasteners 126, such as a plurality of bolts. The rim portion 122 includes a central rim aperture 128, and, as described in further detail below, the rim aperture 128 permits access to the internal compartment of the frame 102 (shown elsewhere). The rim portion 122 may be constructed of one or more robust materials such as metals. Examples of such metals include aluminum, such as 6061 T6 or 6066 aluminum. The rim portion 122 may be formed in a forging process.

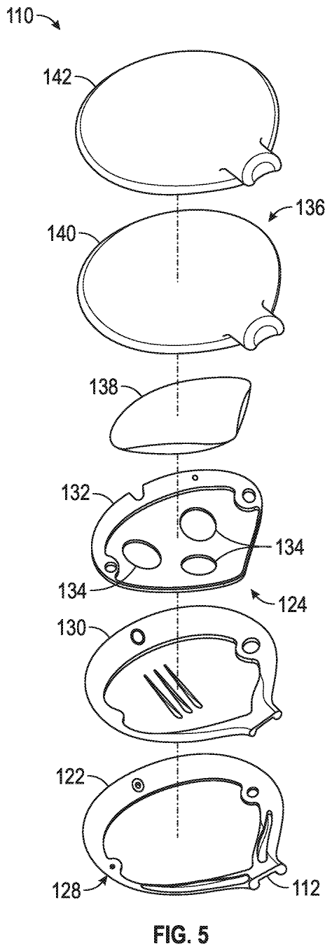

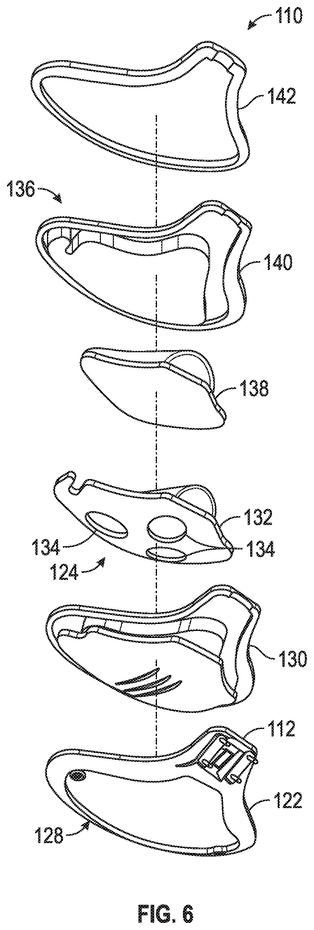

Referring specifically to the exploded views of FIGS. 5 and 6, the cushion assembly 124 includes a lower base 130 positioned generally above the rim portion 122 and in the rim aperture 128 when the cushion assembly 124 is coupled to the rim portion 122. The lower base 130 may be constructed of one or more relatively lightweight materials, such as polymers, such as UV-stabilized polypropylene (PP). The lower base 130 may be formed in a molding process. The cushion assembly 124 also includes an inner base 132 positioned generally above the lower base 130. The inner base 132 illustratively includes a plurality of base apertures 134, which reduce the weight of the inner base 132. The inner base 132 may be constructed of one or more relatively strong materials, such as metals including steel, for example grade 50 steel. The inner base 132 may be formed in one or more sheet metal forming processes. The cushion assembly 124 further includes a cushion portion 136 positioned generally above the inner base 132 and, in some examples, opposite the lower base 130. Illustratively, the cushion portion 136 includes multiple separate layers (that is, stacked and/or joined layers), such as a lower cushion layer 138 and the upper cushion layer 140. Alternatively, the cushion portion 136 may include a unitary layer. The cushion portion 136 may be constructed of one or more relatively compliant materials, such as compressible foams, for example polyol or polyurethane (PU) foam. Relatedly, the upper cushion portion 140 and the lower cushion portion 138 may be constructed from the same material(s) or different material(s), and/or may have the same properties or different properties. For example, the upper cushion portion 140 may have a first spring rate, and the lower cushion portion 138 may have a second spring rate greater than the first spring rate. In such embodiments, the upper cushion portion 140 provides initial/short term comfort (for example, when sitting on the seat in a showroom) and the lower cushion portion 138 provides long term comfort (for example, when sitting on the seat for more than half an hour). The first spring rate may be an indentation force deflection (IFD) in a range of 110N to 160N, a range of 125N to 145N, or about 135N (each at 25 percent deflection, per ASTM D3574, using indenter size of Ø150 mm). The second spring rate may be about 50 percent greater than the first spring rate. The second spring rate may be an IFD in a range of 175N to 225N, a range of 190N to 210N, or about 200N (each at 25 percent deflection, per ASTM D3574, using indenter size of Ø150 mm). The cushion assembly 124 also includes a cushion cover 142 that overlies the cushion portion 136. The cushion cover 142 may be constructed of one or more relatively compliant materials, such as polyvinyl chloride (PVC) or leather.

In some embodiments, the arrangement and materials of the components of the seat assembly 110 facilitate increased aesthetic appeal, reduced costs, and other benefits compared to other seats. For example, the lower base 130, if constructed from a polymer, facilitates reduced costs compared to other seats in which the lower surface is largely constructed of metal components, particularly aesthetically appealing metal components such as powder-painted metal components. Similarly, the lower base 130, if constructed from a polymer, facilitates coupling to the cover 142 via staples (described below) which are relatively inexpensive compared to rivets. As another example, the inner base 132, if constructed from a metal, facilitates reinforcement of the lower base 130 and increased strength for the seat assembly 110. However, the inner base 132, being an internal component, may lack treatments that facilitate aesthetic appeal, such as polishing, thereby reducing costs of the seat assembly 110. As another example, the materials of the components (in particular, if the rim portion 122 is constructed from aluminum and/or the lower base 130 is constructed from a polymer) reduce the weight of the seat assembly 110 relative to other seat assemblies, which lowers the center of gravity of the vehicle and thereby enhances performance and handling of the vehicle.

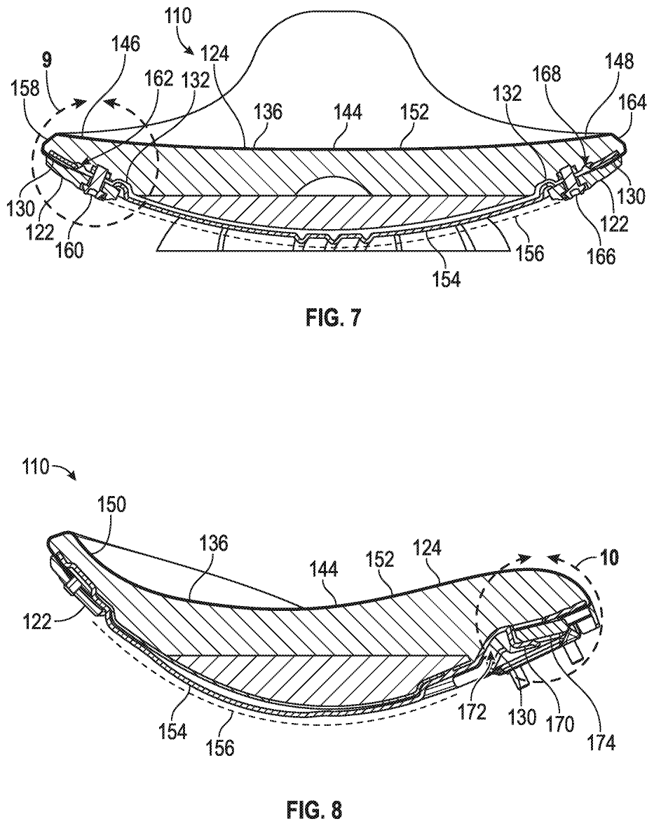

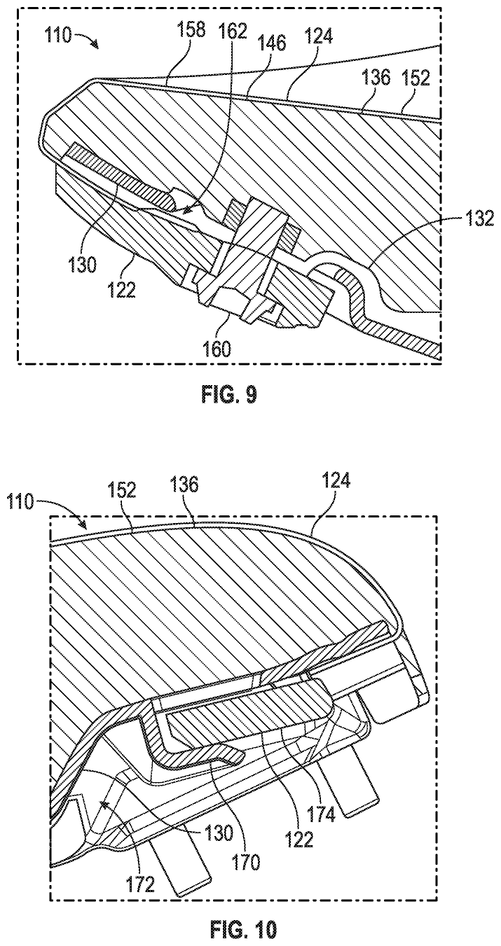

FIGS. 7-10 illustrate sectional views of the seat assembly 110. More specifically, FIGS. 7 and 9 illustrate rear sectional views of the seat assembly 110 and FIGS. 8 and 10 illustrate side sectional views of the seat assembly 110. Illustratively, the cushion portion 136 has a relatively thick middle section 144, to facilitate operator comfort, and relatively thin side sections 146, 148 and a rear section 150, to facilitate aesthetic appeal. Stated another way, the middle section 144 of the cushion portion 136 has a middle thickness, a first side section 146 of the cushion portion 136 has a first side thickness, a second side section 148 of the cushion portion 136 has a second side thickness, and the middle thickness is greater than one or more of the first side thickness or the second side thickness. In certain embodiments, the middle thickness is in a range of 37 mm to 47 mm and the first side thickness and/or the second side thickness are in a range of 7 mm to 17 mm. Similarly, the rear section 150 has a rear thickness that is less than the middle thickness. In certain embodiments, the rear thickness is in a range of 7 mm to 17 mm. Illustratively, the cushion assembly 124 includes a concave upper surface 152, to facilitate operator comfort, and convex lower surface 154 that generally compliments the concave upper surface 152 and provides the cushion portion 136 with the thickness described herein. Relatedly, the convex lower surface 154 and the rim portion 122 together define an aesthetically pleasing convex envelope 156.

Referring specifically to FIGS. 7 and 9, the sides of the seat assembly 110 include fasteners that detachably couple the cushion assembly 124 to the rim portion 122. For example, a first side section 158 of the seat assembly 110 includes a first fastener 160, such as a first bolt, that detachably couples the inner base 132 to the rim portion 122. Illustratively, the lower base 130 includes a first base aperture 162 at the first side section 158 of the seat assembly 110 through which the first fastener 160 extends. The inner base 132 and the rim portion 122 extend into the first base aperture 162 and engage each other to provide a firm connection. Similarly, a second side section 164 of the seat assembly 110 includes a second fastener 166, such as a second bolt, that detachably couples the inner base 132 to the rim portion 122. Illustratively, the lower base 130 includes a second base aperture 168 at the second side section 164 of the seat assembly 110 through which the second fastener 166 extends. The inner base 132 and the rim portion 122 extend into the second base aperture 168 and engage each other to provide a firm connection.

Referring specifically to FIGS. 8 and 10, the front of the seat assembly 110 includes a latch 170 that detachably couples the cushion assembly 124 to the rim portion 122. For example, the lower base 130 includes the latch 170, and the latch 170 is detachably received in a latch aperture 172 of the rim portion 122 and hooks behind a catch surface 174 of the rim portion 122.

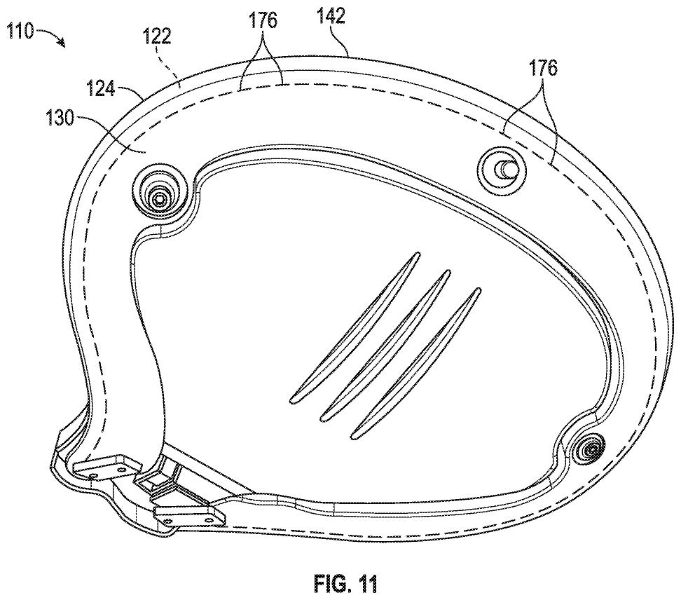

FIG. 11 illustrates the seat assembly 110 with the rim portion 122 in phantom lines. Illustratively, the seat assembly 110 includes a plurality of fasteners 176 that secure the cushion cover 142 relative to the cushion portion 136 (shown elsewhere), such as a plurality of staples. The fasteners 176 may extend through the cushion cover 142 and into the lower base 130. The fasteners 176 may be obscured by the rim portion 122 when the cushion assembly 124 is coupled to the rim portion 122, thereby facilitating the aesthetically pleasing appearance of the seat assembly 110. Advantageously, the fasteners 176, if provided as staples, may be easier to service than rivets-staples can be removed with a flat tool, while rivets typically require more complex tools. Further, staples can be replaced with less complex tools than rivets.

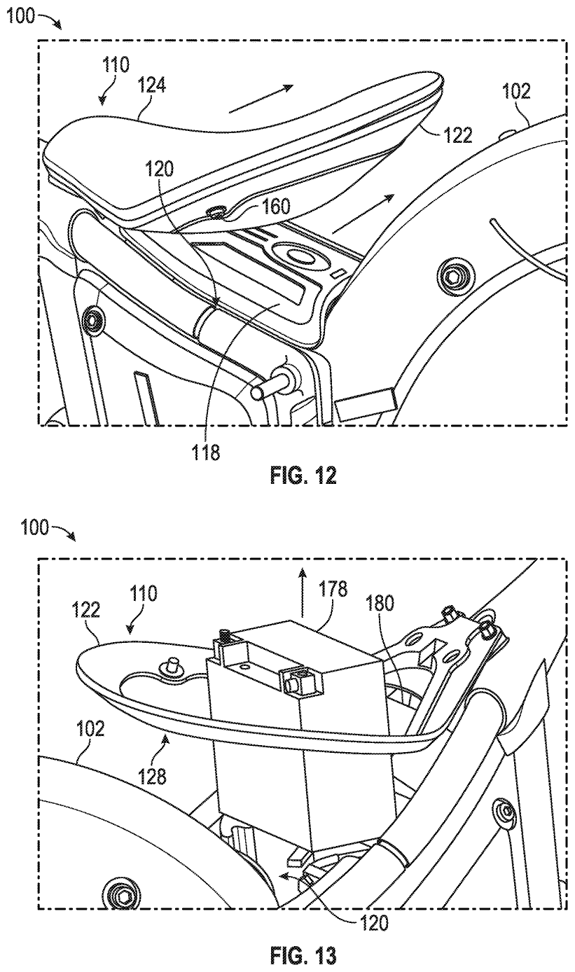

Referring to FIGS. 12 and 13 and as described briefly above, the seat assembly 110 facilitates access to the internal compartment of the frame 102 of the vehicle 100 via the access opening 120. Referring specifically to FIG. 12, the cushion assembly 124 is detached from the rim portion 122 by detaching the first fastener 160 and the second fastener 166 (shown elsewhere) from the seat assembly 110 and then moving the cushion assembly 124 in a general rearward direction such that the latch 170 (See FIG. 10) disengages the rim portion 122. The compartment cover 118 is then detached from the frame 102, by moving the compartment cover 118 in a general rearward direction, to permit access to the internal compartment via the access opening 120. Referring specifically to FIG. 13, one or more internal components, such as a battery 178 and a fuse assembly 180, are then accessible via the rim aperture 128 and the access opening 120. Illustratively, the battery 178 may be removed from the internal component by moving the battery 178 in a general vertical direction and through the access opening 120 and the rim portion 122.

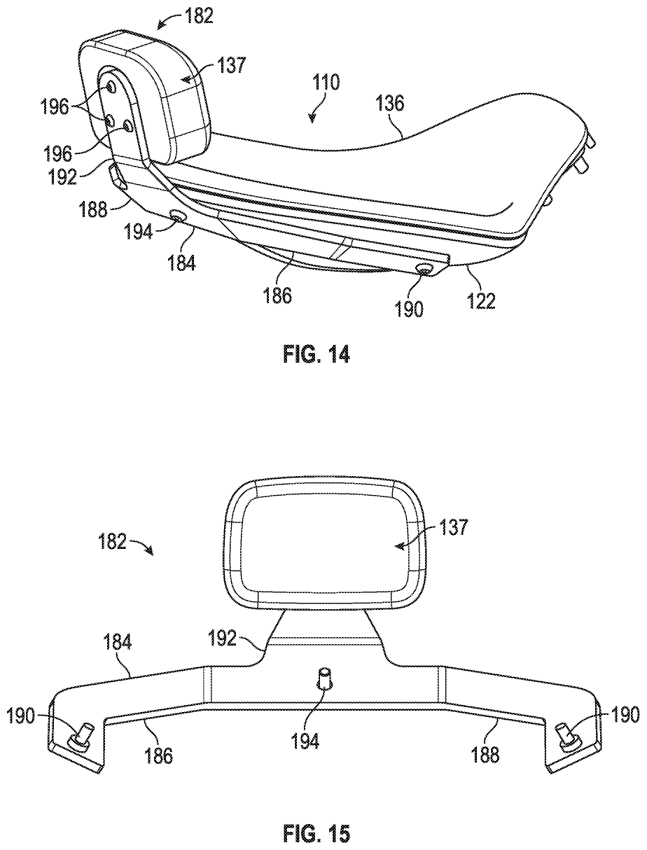

FIG. 14 illustrates the seat assembly 110 coupled to a backrest assembly 182, and FIG. 15 illustrates the backrest assembly 182. The backrest assembly 182 is generally disposed rearwardly of the rim portion 122 and the cushion portion 136, and the backrest assembly 182 supports the lower back of a rider and enhances rider comfort. Illustratively, the backrest assembly 182 includes a bracket or coupling 184 and a cushion portion 137 that supports the rider. The coupling 184 includes a first arm portion 186 and a second arm portion 188 that generally extend along the sides of the rim portion 122. The arm portions 186, 188 include fasteners 190 for coupling the backrest assembly 182 to the seat assembly 110. The fasteners 190 may be the fasteners 160, 166 or replace the fasteners 160, 166 (shown elsewhere). The coupling 184 also includes a neck portion 192 disposed between the first arm portion 186 and the second arm portion 188. The neck portion 192 includes a fastener 194 for coupling the backrest assembly 182 to the seat assembly 110. The neck portion 192 couples to the cushion portion 137 opposite the arm portions 186, 188 via one or more fasteners 196 (FIG. 14).

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A seat assembly for a vehicle, comprising:
a rim portion configured to be coupled to a frame of the vehicle, the rim portion including an aperture;
a cushion assembly detachably coupled to the rim portion, the cushion assembly including:
a lower base positioned in the aperture when the cushion assembly is coupled to the rim portion;
an inner base coupled to the lower base; and
a cushion portion coupled to the inner base.

2. The seat assembly of claim 1, wherein the aperture is a rim aperture, the lower base includes a base aperture, and the inner base is coupled to the rim portion at the base aperture.

3. The seat assembly of claim 2, further comprising a fastener coupling the inner base to the rim portion at the base aperture.

4. The seat assembly of claim 3, wherein the fastener is detachable from the inner base and the rim portion to facilitate detachment of the cushion assembly from the rim portion.

5. The seat assembly of claim 1, further comprising a fastener coupling the cushion assembly to the rim portion, the fastener being detachable from the cushion assembly and the rim portion to facilitate detachment of the cushion assembly from the rim portion.

6. The seat assembly of claim 5, wherein the cushion assembly comprises a latch detachably coupling the cushion assembly to the rim portion.

7. The seat assembly of claim 1, wherein the cushion assembly comprises a latch detachably coupling the cushion assembly to the rim portion.

8. The seat assembly of claim 1, wherein the cushion assembly further includes a cushion cover overlying the cushion portion.

9. The seat assembly of claim 8, further comprising fasteners coupling the cushion cover to the cushion portion.

10. The seat assembly of claim 9, wherein the fasteners are at least partially obscured by the rim portion when the cushion assembly is coupled to the rim portion.

11. The seat assembly of claim 9, wherein the fasteners are staples.

12. The seat assembly of claim 1, wherein the cushion portion has a middle section with a middle thickness and a side section with a side thickness, the side thickness being less than the middle thickness.

13. The seat assembly of claim 12, wherein the middle thickness is in a range of 37 mm to 47 mm and the side thickness is in a range of 7 mm to 17 mm.

14. The seat assembly of claim 1, wherein the cushion portion has a middle section with a middle thickness and a rear section with a rear thickness, the rear thickness being less than the middle thickness.

15. The seat assembly of claim 14, wherein the middle thickness is in a range of 37 mm to 47 mm and the rear thickness is in a range of 7 mm to 17 mm.

16. The seat assembly of claim 1, wherein the cushion assembly includes a concave upper surface and a convex lower surface.

17. The seat assembly of claim 1, wherein the cushion portion includes an upper cushion layer and a lower cushion layer.

18. The seat assembly of claim 17, wherein the upper cushion layer has a first spring rate, the lower cushion layer has a second spring rate, and the second spring rate is greater than the first spring rate.

19. A vehicle comprising:
a frame including an internal compartment, the internal compartment having an access opening;
a compartment cover detachably coupled to the frame and adjacent to the access opening of the internal compartment;
a seat assembly coupled to the frame, the seat assembly including:
a rim portion coupled to the frame, the rim portion including an aperture; and
a cushion assembly detachably coupled to the rim portion adjacent to the aperture of the rim portion;
wherein the cushion assembly is detachable from the rim portion and the compartment cover is moveable relative to the frame to permit access to the internal compartment through the aperture and the access opening.

20. The vehicle of claim 19, wherein the cushion assembly includes a cushion portion and a lower base coupled to the cushion portion, the lower base being positioned in the aperture of the rim portion when the cushion assembly is coupled to the rim portion.

21. The vehicle of claim 20, wherein the cushion assembly further includes a latch being selectively detachable from the rim portion to facilitate detachment of the cushion assembly from the rim portion.

22. The vehicle of claim 20, wherein the cushion assembly further includes an inner base disposed between the cushion portion and the lower base.

23. The vehicle of claim 22, wherein the aperture is a rim aperture, the lower base includes a base aperture, and the inner base contacts the rim portion at the base aperture.

24. The vehicle of claim 23, further comprising a fastener coupling the inner base to the rim portion at the base aperture.

25. The vehicle of claim 24, wherein the fastener is detachable from the inner base and the rim portion to facilitate detachment of the cushion assembly from the rim portion.

26. The vehicle of claim 22, wherein the rim portion is constructed of a metal, the lower base is constructed of a polymer, and the inner base is constructed of a metal.

27. The vehicle of claim 19, wherein the cushion assembly includes a cushion portion and a cushion cover overlying the cushion portion.

28. The vehicle of claim 27, further comprising fasteners coupling the cushion cover to the cushion portion, the fasteners being obscured by the rim portion when the cushion assembly is coupled to the rim portion.

29. The vehicle of claim 28, wherein the fasteners are staples.

30. The vehicle of claim 19, wherein the seat assembly includes a front section secured to the frame and a rear section disposed above the compartment cover, the rear section and the compartment cover defining a gap therebetween.

31. The vehicle of claim 19, further comprising at least one of a battery and a fuse assembly disposed within the internal compartment.
